(19) United States
(12) Patent Application Publication
(10) Pub. No.: US 2015/0028080 A1
(43) Pub. Date: Jan. 29, 2015

(54) METHOD FOR THE COHESIVE CONNECTION OF TWO COMPONENTS USING INTEGRALLY FORMED PORTIONS FOR MANIPULATING SAID COMPONENTS

(71) Applicant: Siemens Aktiengesellschaft, Munich (DE)

(72) Inventors: Stefan Brussk, Mulheim an der Ruhr (DE); Bora Kocdemir, Essen (DE); Tim Schreiber, Witten (DE); Shilun Sheng, Oberhausen (DE); Frank Truckenmuller, Bochum (DE); Tino Uravic, Essen (DE)

(73) Assignee: Siemens Aktiengesellschaft, Munich (DE)

(21) Appl. No.: 14/373,839

(22) PCT Filed: Jan. 11, 2013
(86) PCT No.: PCT/EP2013/050435

§ 371 Date: Jul. 22, 2014

(30) Foreign Application Priority Data
Feb. 6, 2012 (EP) 12154045.4

(51) Int. Cl. B23K 31/02; B23K 37/00

(52) U.S. Cl. CPC B23K 31/02; B23K 37/003; B23K 2201/00
USPC 228/101

(57) ABSTRACT

A method for the cohesive connection of two components, in particular two rotating shaft parts, in a connecting region, is provided, wherein integrally formed portions for manipulating the surface geometry of the components are positioned adjacent to the connecting region, wherein the two components are welded together and wherein a subsequent heat treatment is carried out for the targeted introduction of residual compressive stresses, the distribution of which is also determined by the manipulated surface geometry.

### CROSS REFERENCE TO RELATED APPLICATIONS

This application is the US National Stage of International Application No. PCT/EP2013/050435 filed Jan. 11, 2013, and claims the benefit thereof. The International Application claims the benefit of European Application No. EP12154045 filed Feb. 6, 2012. All of the applications are incorporated by reference herein in their entirety.

### FIELD OF INVENTION

The invention relates to a method for the cohesive connection of two components, in particular of two rotating shaft parts, in a connection region.

### BACKGROUND OF INVENTION

When components are connected cohesively to one another by welding, and therefore by means of a welded seam, this changes the material properties of the components in the region of the connection. This change in the material properties is due to the effect of heat during the welding process, on account of which the affected region is also termed the heat affected zone. In general, the change in the material properties is disadvantageous and therefore undesirable.

During the production of welded connections between the segments of a turbine shaft, for example, high tensile residual stresses arise in the region of the welded seam, which are taken into account during the configuration of the components and of the welded connections in the planning phase or are reduced by means of a subsequent treatment of the welded-together components. A very common subsequent treatment method provides, for example, for the introduction, into the welded-together components, of compressive residual stresses near the surface by rolling or shot peening, which residual stresses counteract the tensile residual stresses present. Such methods for the subsequent treatment of the welded-together components are, however, most laborious and are effective only in the region close to the surface.

### SUMMARY OF INVENTION

Proceeding herefrom, the invention is based on an object of proposing an alternative method for the cohesive connection of two components.

This object is achieved, according to the invention, by means of a method having the features of the claims.

The method serves for the cohesive connection of two components, in particular of two rotating shaft parts, so for example two turbine shaft parts, in a connection region, wherein integrally formed portions for manipulating the surface geometry of the components are positioned adjacent to the connection region, wherein the two components are welded together and wherein a subsequent heat treatment is carried out in order to introduce, in a targeted manner, compressive residual stresses, the distribution of which is influenced by the manipulated surface geometry.

In this context, the integrally formed portions are preferably used exclusively for influencing the effect of the subsequent heat treatment. This means that the integrally formed portions are not involved in the cohesive connection and that, in particular between the integrally formed portions, no welded seam is formed. Instead, the distribution of the compressive residual stresses introduced by the subsequent heat treatment is manipulated with the aid of the integrally formed portions, with the compressive residual stresses counteracting the tensile residual stresses present and thus at least partially cancelling the effect of the latter. Overall, this gives rise to a distribution of tensile residual stresses and compressive residual stresses which has been changed by the subsequent heat treatment and which is substantially more favorable than the distribution before the subsequent heat treatment. The combination of manipulation of the surface geometry with the subsequent heat treatment then replaces a subsequent treatment of the welded-together components, in which the latter undergo a simple subsequent heat treatment and/or a surface treatment by rolling or shot peening.

In particular in the case of rotationally symmetric components which are lined up with one another along the axis of symmetry and are welded together, a method variant in which annular integrally formed portions are provided is advantageous. This is for example the case for rotor segments of a turbine shaft.

A variant of the method in which the integrally formed portions are positioned at a distance from the connection region, and in particular in the boundary region of what is termed the heat affected zone (HAZ), is further expedient. A positioning of this type has proven to be favorable in principle, wherein, expediently, a shape and position of the integrally formed portions which is adapted to the components is determined numerically for every cohesive connection, for example by a model calculation.

In particular in the case of components having particularly large dimensions, a method variant in which the subsequent heat treatment is carried out locally in the connection region is advantageous since, in so doing, the expenditure for the subsequent heat treatment is significantly reduced in comparison with a subsequent heat treatment which extends over the entire volume of the welded-together components.

In addition, a method variant in which an annealing operation, and in particular a stress-relief annealing operation or a tempering treatment, is provided as the subsequent heat treatment is advantageous. By such a subsequent heat treatment, tensile residual stresses in the welded-together components may be reduced without introducing compressive residual stresses.

Moreover, a method variant in which a subsequent heat treatment is carried out during which, in a partial step, the welded-together components are sprayed with a liquid, in particular with an oil or with water, is advantageous. The purpose of this is to generate a pronounced temperature gradient close to the surface in the welded-together components, compressive residual stresses thus being introduced to a greater extent in the corresponding region. In this context, it is of particular advantage if the partial step in which the components are sprayed with the liquid is started at a temperature which is equal to or below the temperature for a holding phase of the stress-relief annealing operation. This partial step of the subsequent heat treatment is then expediently provided at the end of the holding phase of the stress-relief annealing operation and is thus, in this case, part of a controlled cooling phase.

Depending on the intended use of the welded-together components, it is also advantageous to mechanically remove the integrally formed portions after the heat treatment. This is particularly valid if a positive effect is achieved by the associated reduction in weight or if, as in the case of turbine shaft parts, this avoids an unfavorable influence on the mode of operation, in this case the flow characteristics.

Also preferred is a method variant in which a subsequent heat treatment is carried out, during which, in a partial step during a spray treatment, the welded-together components are sprayed with water, and in which the integrally formed portions are mechanically removed after the heat treatment. In this context, the integrally formed portions are preferably or exclusively used for the purpose of shifting the compressive residual stresses generated by the spray treatment in the region of the welded seam. This means that the integrally formed portions are not involved in the cohesive connection, and that, in particular between the integrally formed portions, no welded seam is formed. The distribution of the compressive residual stresses introduced by the spray treatment is predetermined with the aid of the integrally formed portions, with the compressive residual stresses counteracting the tensile residual stresses present and thus at least partially cancelling the effect of the latter. By removing the integrally formed portions, the maximum compressive residual stresses are shifted in the region of the welded seam. Overall, this gives rise to a changed distribution of tensile residual stresses and compressive residual stresses which is substantially more favorable than the distribution without spray treatment and removal of the integrally formed portions. This achieves a significant depth effect of the compressive residual stresses. The combination of manipulation of the surface geometry and removal of the integrally formed portions with the subsequent heat treatment then replaces a subsequent treatment of the welded-together components, in which the latter undergo a simple subsequent heat treatment and/or a surface treatment by rolling or shot peening.

### BRIEF DESCRIPTION OF THE DRAWINGS

Exemplary embodiments of the invention will be explained in more detail below with reference to a schematic drawing, in which:

FIG. 1 shows, in a sectional representation, a detail of two welded-together rotor segments of a turbine shaft having integrally formed portions, and

FIG. 2 shows, in a sectional representation, a detail of the rotor segments of a turbine shaft after removal of the integrally formed portions.

In all figures, mutually corresponding parts are in each case provided with the same reference signs.

### DETAILED DESCRIPTION OF INVENTION

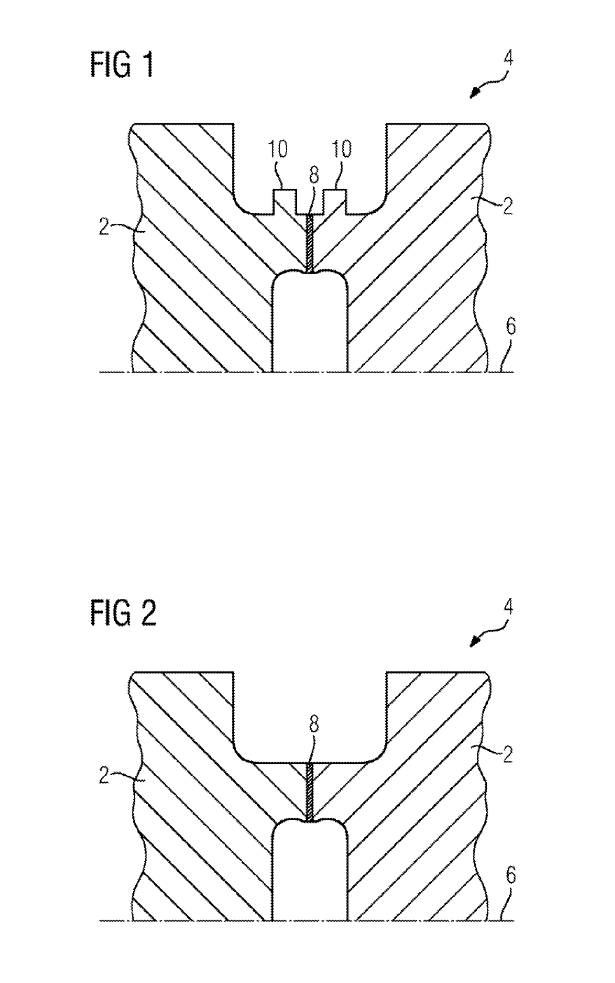

The method proposed here for the cohesive connection of two components is for example provided in order to permanently connect rotor segments 2 of a turbine shaft 4 to one another, as is shown in a schematic detail in FIG. 1. Within the context of the production process for the turbine shaft 4, those rotor segments 2 are lined up with one another along an axis of symmetry 6 and are connected together via at least one welded seam 8 which extends predominantly transversely to the axis of symmetry 6.

The welding of the rotor segments 2 is performed for example by narrow-gap welding, wherein, irrespective of the nature of the welding method, tensile residual stresses are introduced in the connection region, that is to say in the region of the welded seam 8 and the immediate vicinity, in the course of the welding procedure, which reduces the load-bearing capacity of the cohesive connection and thus has a negative effect on the life expectancy of the turbine shaft 4.

In order to increase the resistance of the cohesive connection, the effective tensile residual stresses in the connection region, that is to say in the region of the welded seam 8 and the immediate vicinity, are subsequently reduced again. To this end, a subsequent heat treatment is carried out after the welding operation, whereby compressive residual stresses, which counteract the tensile residual stresses, are introduced in a targeted manner. However, the subsequent heat treatment in accordance with the method presented here goes above and beyond the simple subsequent heat treatment of welded connections, such as a simple stress-relief annealing operation, which are known per se.

In order to achieve a desired distribution of compressive residual stresses, which are introduced into the connection region in the context of the subsequent heat treatment, the surface geometry of the rotor segments 2 is manipulated, in a previous method step, before the welding of the rotor segments 2. Annular integrally formed portions 10, arranged symmetrically with respect to the axis of symmetry 6, are provided for the rotor segments 2 in the connection region, that is to say in that region in which the welded connection will later be formed, and help to predefine a geometry of the surface which has been found to be favorable. A favorable surface geometry is expediently determined with the aid of model calculations in the planning phase for the rotor segments 2 and the turbine shaft 4. In the manufacture of the rotor segments 2, the integrally formed portions 10 determined in this way are taken into account from the very beginning. Thus, if the rotor segments 2 for example are castings, the integrally formed portions 10 are already taken into account in the negative mold for the casting operation.

By the surface geometry of the rotor segments 2 in the connection region, which has been changed by the integrally formed portions 10, a distribution of compressive residual stresses which is influenced by the surface geometry is then introduced into the welded-together rotor segments 2 within the framework of the subsequent heat treatment, wherein, in accordance with the principle of superposition, the compressive residual stresses introduced partially cancel out the given tensile residual stresses, which leads overall to a substantially more favorable distribution of tensile residual stresses and compressive residual stresses in the entire turbine shaft 4.

In the context of the subsequent heat treatment, the connection region is preferably heated up, in a locally limited manner, to a temperature between 400° C. and 800° C. in a heating-up phase. After an immediately subsequent holding phase, for example at the level of what is termed the stress-relief annealing temperature, the welded-together rotor segments 2 are sprayed with water within the framework of a controlled cooling phase, in order in this manner to generate a pronounced temperature gradient close to the surface, whereby compressive residual stresses are built up to a greater extent in this region.

In order that the flow in the turbine for which the turbine shaft 4 is provided is not negatively affected by the integrally formed portions 10, the integrally formed portions 10 are mechanically removed, for example sawn off, after the subsequent heat treatment.

The invention is not restricted to the exemplary embodiment described above. Rather, other variants of the invention may also be derived herefrom by a person skilled in the art without departing from the subject matter of the invention. In particular, all individual features described in combination with the exemplary embodiment may further also be combined in another manner with one another without departing from the subject matter of the invention.

1. A method for the cohesive connection of two components in a connection region, comprising:
positioning integrally formed portions for manipulating the surface geometry of the components adjacent to the connection region,
welding the two components together, and
wherein a subsequent heat treatment is carried out in order to introduce, in a targeted manner, compressive residual stresses, the distribution of which is influenced by the manipulated surface geometry.

2. The method as claimed in claim 1,
wherein annular integrally formed portions are provided.

3. The method as claimed in claim 1,
wherein the integrally formed portions are at a distance from the connection region.

4. The method as claimed in claim 1,
wherein the subsequent heat treatment is carried out locally in the connection region.

5. The method as claimed in claim 1,
wherein an annealing operation is provided as the subsequent heat treatment.

6. The method as claimed in claim 1,
wherein a subsequent heat treatment is carried out in which, in a partial step, the welded-together components are sprayed with a liquid.

7. The method as claimed in claim 6,
wherein the partial step in which the components are sprayed with the liquid is started at a temperature which is equal to or below the temperature for a holding phase of a stress-relief annealing operation.

8. The method as claimed in claim 1,
wherein the integrally formed portions are mechanically removed after the heat treatment.

9. The method as claimed in claim 1, wherein the two components comprise two rotating shaft parts.

10. The method as claimed in claim 5, wherein the annealing operation comprises a stress-relief annealing operation.

11. The method as claimed in claim 6, wherein the liquid comprises water.
